(19) United States
(12) Patent Application Publication
(10) Pub. No.: US 2026/0339808 A1
(43) Pub. Date: Oct. 29, 2026

(54) CERTIFIED TELEMETRY DATA COLLECTION IN CHIPLET PROCESSOR ARCHITECTURE

(71) Applicant: Openchip & Software Technologies S.L., Barcelona (ES)

(72) Inventors: Francesc Guim Bernat, Barcelona (ES); Violante Moschiano, Avezzano (IT); Edgar Gonzalez Pellicer, Girona (ES)

(21) Appl. No.: 19/629,793

(22) Filed: Mar. 26, 2026

Related U.S. Application Data
(63) Continuation of application No. PCT/EP2025/071997, filed on Jul. 30, 2025.

(51) Int. Cl. G06F 11/34

(52) U.S. Cl. CPC G06F 11/3428

(57) ABSTRACT

Aspects of establishing certified telemetry in processing circuitry, including in a chiplet-based implementation, are described. An example method performed by telemetry monitoring circuitry includes: obtaining telemetry data produced from compute operations performed in one or more hardware resources (e.g., compute tiles, memory controllers, etc.) of a compute platform; generating a signature of the telemetry data, based on a hash or derivation of the telemetry data; and communicating certified telemetry data to an external entity, to provide the telemetry data and the signature of the telemetry data. In further examples, the certified telemetry data is collected, validated, and aggregated from multiple chiplets of a package or system-on-chip, to provide a certification of telemetry data collected across multiple hardware elements. The certified telemetry data may be used for purposes such as performance monitoring, service level agreement (SLA) compliance, resource usage tracking, security event analysis, and the like.

### PRIORITY

This application is a continuation of International Application No. PCT/EP2025/071997, filed Jul. 30, 2025, which is incorporated herein by reference in its entirety.

### STATEMENT OF FUNDING

This invention was made with government support under Grant UNICO-IPCEI-2023-001 funded by the European Union-Next Generation EU, Important Projects of Common European Interest (IPCEI).

### BACKGROUND

Telemetry generally refers to processes for monitoring, collecting, transmitting, and analyzing data from different sources of a computing system. The analysis of this data can be used to gain insights related to system performance and operational health and used to trigger various responses. The data that is collected from telemetry operations is often referred to as “telemetry data” or simply “telemetry”.

Telemetry operations are complicated by complex edge-cloud deployments that offer services for multiple tenants and users from different types of providers. Specifically, telemetry operations for compute services can be complicated when one party is offering access to the services and another party is implementing the services. For example, some network operators (e.g., telecommunication service providers or “telcos”) who are willing to own the whole infrastructure, including compute capabilities, may offer services to their own subscribers and rent compute capabilities to other service providers (e.g., cloud service providers) to run a software stack. On the other hand, cloud service providers may not want to run their software stack on hardware provided by different operators (e.g., provided by telecommunication service providers (“telcos”) or other on-demand or managed compute service providers), due to reasons such as IP protection, security, and quality of service. As a result, many cloud service providers choose to use other operators as network infrastructure providers only and will deploy proprietary, closed racks at telco edge locations. Such arrangements present a variety of challenges for collecting and analyzing telemetry data.

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts an architecture of a computing system applicable to telemetry data management and processing techniques, according to an example.

FIG. 2 depicts a flowchart of operations for generating certified telemetry data such as in a chiplet architecture, according to an example.

FIG. 3 depicts a chiplet configuration used in a processor architecture adapted for certified telemetry data collection and distribution, according to an example.

FIG. 4 depicts a flowchart of certified telemetry data collection and distribution operations performed by telemetry monitoring circuitry, such as implemented in a telemetry monitoring unit of a processing chiplet, according to an example.

FIG. 5 depicts an example configuration of a telemetry aggregation and certification chiplet adapted for certified telemetry data collection and distribution, according to an example.

FIG. 6 depicts a flowchart of certified telemetry data collection and distribution operations performed by telemetry monitoring circuitry, such as implemented in a telemetry aggregation and certification chiplet, according to an example.

FIG. 7 depicts an architectural overview of an integrated compute platform including telemetry monitoring circuitry in a processing chiplet and telemetry monitoring circuitry in a telemetry aggregation and certification chiplet, according to an example.

FIG. 8 depicts a flowchart of an example method for generating certified telemetry data in a compute platform, according to an example.

FIG. 9 depicts a hardware arrangement of a data center used to provide multiple implementations or instances of a computing system, according to an example.

FIGS. 10A and 10B depict arrangements of a chip assembly with expanded views of chiplets and processing units, according to an example.

FIG. 11 depicts a block diagram of a computing system, according to an example.

### DETAILED DESCRIPTION

The following introduces implementations of computer hardware units for telemetry operations, applicable in processor architectures such as chiplet-based processors, System-on-chip (SoC) circuitry, System-in-Package (SiP) or System-on-Package (SoP) circuitry, and other modular packaging implementations of processor circuitry. The following hardware implementation specifically provides an architecture for offering “certified” or “verified” telemetry data, which enables a controlled and secure access to telemetry data while certifying, verifying, or attesting that this telemetry data is legitimate, trustworthy, untampered, authentic, etc.

In current deployments, certified or fully verified telemetry cannot be provided, because there are almost always intermediate stacks and components that collect and handle raw data (e.g., counters, logs, measurements) from telemetry sources before the telemetry data is provided to end users or customers of the resources. Thus, in existing computing deployments, tenants would need to trust the resource owner, the operator of the resource, and the manufacturers of the resource to ensure that the telemetry data has not been accessed, modified, manipulated, or fabricated between the time that the telemetry data was collected and the time that the telemetry data is communicated to other parties.

The proposed architecture exposes mechanisms to support a multi-tenant and multi-resource collection and validation of certified telemetry data, including for telemetry data provided across multiple chiplets, packages, platforms, or domains. This can assist a shared data center or platform that pools and shares compute, memory, storage, and/or network resources at multiple levels or in multiple hierarchies but uses isolation measures such as security isolation, QoS isolation, and the like to keep each tenant's data and related telemetry data secure. The proposed architecture can coordinate with these security and isolation mechanisms to: (1) certify that performance counters and telemetry data values that were exposed by the resources where they are allocated (e.g., an allocated set of cores on one or more chiplets) are only internally accessible and are not accessible to other tenants or users sharing the same platform; (2) certify that the telemetry data values that are accessed via network interfaces (e.g., with out of band requests) are authentically generated by the platform where the services are hosted; and (3) certify that the telemetry data values have not been modified or manipulated by any other entity before arriving to the customer or tenant.

The proposed architecture includes multiple forms of telemetry monitoring logic to be deployed in a processing chiplet, a baseboard management controller (BMC), and/or other discrete processing controllers or components of computing platform hardware, generally referred to as “processing circuitry” or “circuitry”. This telemetry monitoring logic enables a telemetry data tracking system to certify that a particular tenant “owns” a particular partition or portion of the compute platform, and to specify which other tenants have access to any telemetry data that are generated (e.g., in the resources associated with that particular tenant partition). Additionally, the telemetry monitoring logic enables individual tenants to access the certified telemetry data after providing a properly signed and authenticated request. This telemetry monitoring logic also enables registration of the telemetry data to corresponding public keys, so that telemetry data can be encrypted and become accessible only to the particular requesting tenant or authorized user. This telemetry monitoring logic can be implemented in multiple locations of a computing platform, for example, with a hierarchy (or multiple levels) of management functions that collect and certify telemetry data across the computing platform.

The following approaches are not limited to specific implementation in a chiplet architecture. However, to enhance the collection of telemetry data in a chiplet-based processor architecture, some of the following implementations also operate a specialized type of telemetry agent. In some examples this telemetry agent may be provided in a dedicated chiplet operating in an SoC or SiP package, referred to as a “telemetry aggregation and certification chiplet”. This telemetry aggregation certification chiplet offers functionality for collecting and managing certified telemetry data, including functionality to validate telemetry data signatures from different sources (e.g., different signatures from different chiplets, which may involve different signature types or protocols to authenticate) and to create a package-wide or platform-wide (e.g., device-wide, system-wide) signature that can be later used to authenticate the certified telemetry data as authentic and legitimate.

The telemetry monitoring, collection, aggregation, and certification operations provided by either type of chiplet (e.g., a telemetry monitoring logic in a processing chiplet, or a telemetry aggregation logic located in a dedicated telemetry aggregation and certification chiplet) can apply various types of verification, validation, signatures, certificates, coordination, and/or mapping techniques to assist telemetry data collection and analysis for a variety of use cases. These include but are not limited to: resource usage tracked for billing and auditing purposes; measurement values communicated within functional safety and safety critical systems; service level agreement (SLA) compliance results and violations; logic triggered and data generated during dynamic workload orchestration, load balancing, and error conditions; power consumption, usage of particular types of power, carbon emissions, and sustainability measures employed; tracking of regulatory and legal compliance; security events, access attempts, cryptographic operations, and integrity checks; etc.

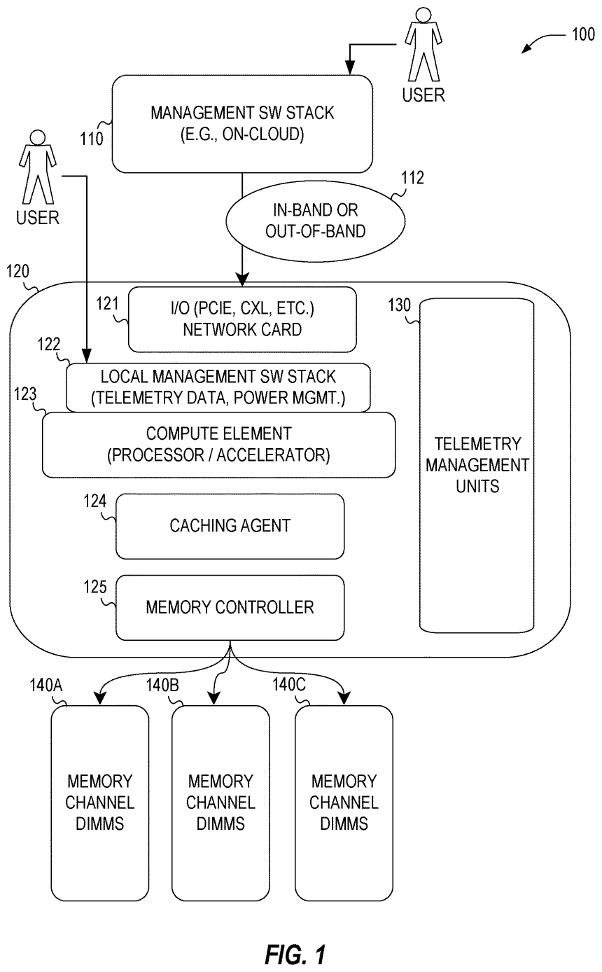

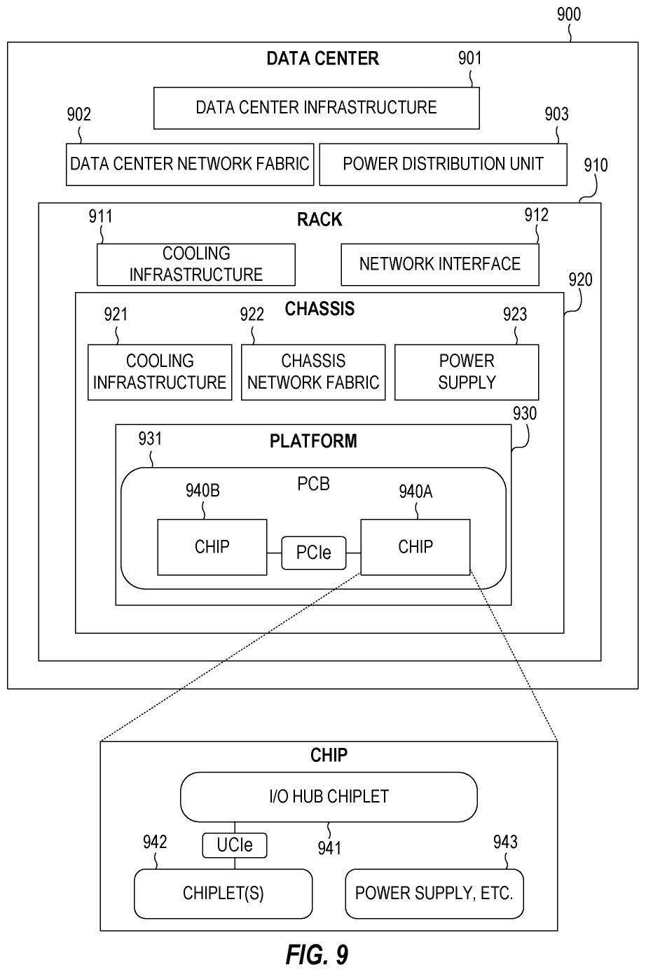

FIG. 1 depicts an example architecture of a computing system, applicable for implementing the certified telemetry data processing techniques discussed herein. This architecture shows a compute platform 120 (e.g., provided from circuitry implemented as an SoC, SiP, SoP, or as a compartmentalized chipset with multiple chips and packages) that includes a network interface 121 to perform I/O operations (e.g., with network communication circuitry), a compute element 123 (e.g., a central processing unit (CPU), accelerator, etc.), and a local management software stack 122 (e.g., loaded software instructions and data) that executes on the compute element 123. Additional implementation examples of the compute platform 120 are provided with reference to FIGS. 9, 10A, 10B, and 11, discussed below. The compute platform 120 is also depicted as including a caching agent 124 (e.g., circuitry implemented with cache memory on the same chip as the compute element 123 or nearby the compute element 123) and a memory controller 125 (e.g., circuitry implemented on the same chip as the compute element 123 or nearby the compute element 123). The memory controller 125 is used to write and read data from memory units 140A, 140B, 140C, such as respective memory channel modules (e.g., dual in-line memory modules (DIMMS) such as SDRAM modules).

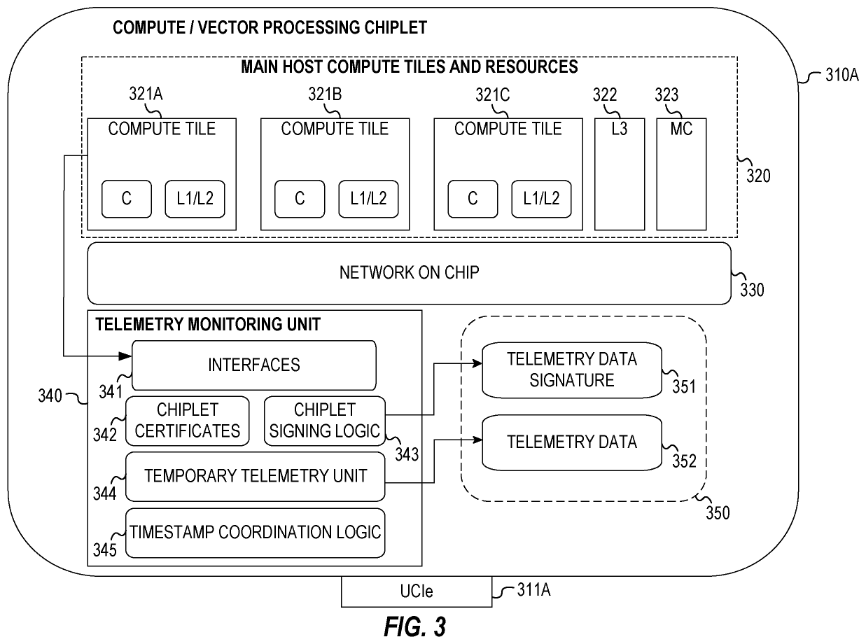

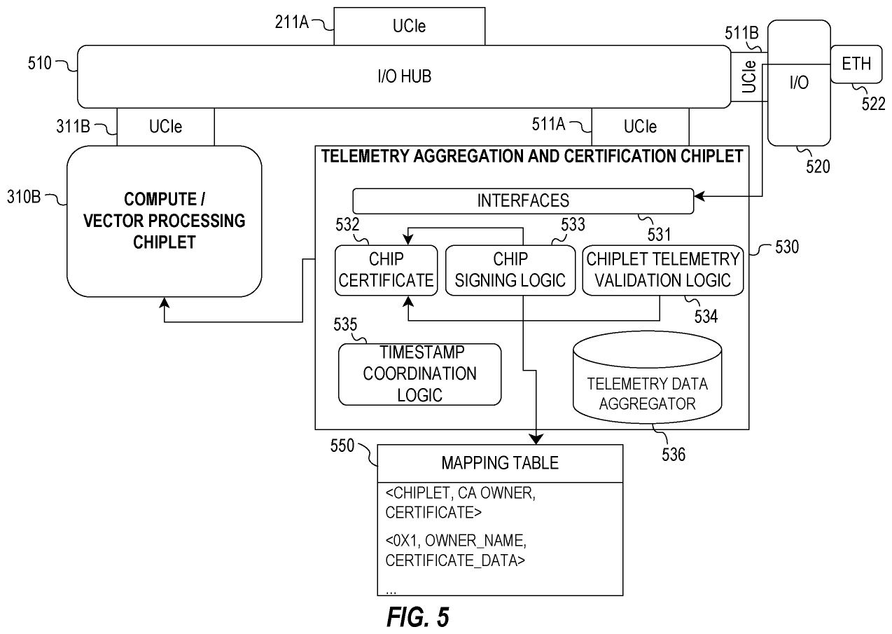

As an operational example, the local management software stack 122 may collect telemetry data in response to hardware events with various platform resources (e.g., events occurring in network interface 121, compute element 123, caching agent 124, memory controller 125, etc.), with such telemetry data collected by various telemetry management units 130 or other circuitry configured to perform the same telemetry data function (e.g., an I/O hub, BMC, network processing unit, or other controller). Example hardware implementations of such telemetry management units 130 are provided with reference to a telemetry monitoring unit 340 depicted in FIG. 3, and a telemetry aggregation and certification chiplet 530 depicted in FIG. 5, but other implementations may be provided. The local management software stack 122 may also perform power management and other functions to control operations of the compute platform 120, including but not limited to remedial actions that respond to hardware events and telemetry data, including from certified telemetry data provided with the present techniques.

The compute platform 120 may receive commands from another implementation of a management software stack 110, such as an on-cloud implementation of management software or a local implementation of management functions (e.g., applicable to functions used across multiple chiplets). The management software stack 110 may provide in-band or out-of-band communications 112 (e.g., received via the network interface 121) that retrieve certified telemetry data and provide commands to respond to detected telemetry data conditions. For instance, a user may provide commands to the local management software stack 122 to retrieve some data related to aspects such as power usage, SLA compliance, resource consumption or availability, or a user may provide commands to the management software stack 110 to monitor telemetry data related to these and related aspects. The telemetry data may be provided by other devices and systems included in, connected to, or under the control of the compute platform 120. Additionally, an I/O hub (not shown in FIG. 1 but discussed in other examples below), BMC, or other controller may be used to coordinate the collection, communication, and management of telemetry data. Any of these entities which uses, retrieves, or accesses telemetry data may be considered as an external entity to which the certified telemetry data is provided.

In existing approaches where telemetry data is collected, telemetry management units typically coordinate information between the counters and the management software stack. For instance, counters may expose telemetry that is provided on an ongoing basis by the different hardware components (e.g., Compute, Memory, Devices). The management software stack typically runs in privileged mode, has access to all the telemetry information, and can process the telemetry information and provide portions of this telemetry information to the user or user stack. Software stacks may perform some level of intermediate computation on the performance counters before returning telemetry data values or making some decision based on the telemetry data values. Such existing approaches are complicated by a number of technical challenges, including in scenarios where the end-consumer of telemetry data cannot validate whether the telemetry data has been altered, tampered with, or incorrectly provided.

With the following approaches, mechanisms are provided in or among the telemetry management units to certify the validity of platform telemetry, particularly in a multi-chiplet architecture where chiplets are provided from different manufacturers or sources. These mechanisms can also be used to secure telemetry data within the overall compute platform or system, so that individual tenants can prevent other tenants from accessing or tampering with their telemetry data. The following architecture thus provides a solution to a technical need to enable computing platforms to accurately secure and authenticate telemetry data and produce a trusted or authenticated form of certified telemetry data. In some examples, this certified telemetry is accompanied by additional trust or attestation measures (e.g., signatures, certificates, attestation measurements, validation data, etc.).

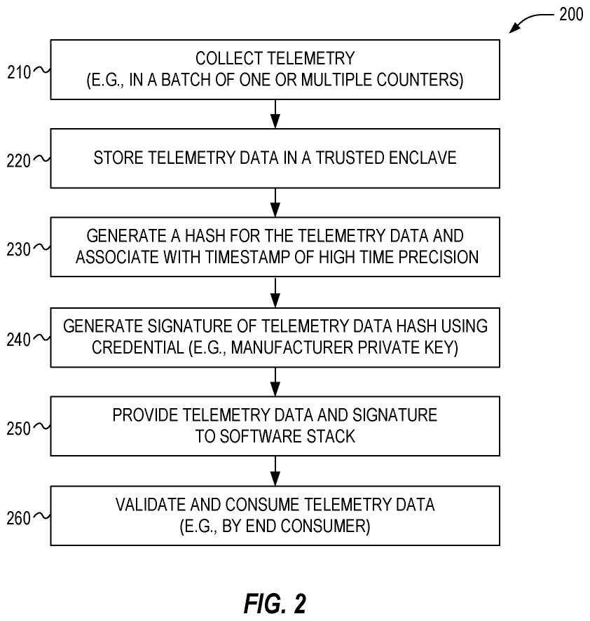

The approaches depicted in FIGS. 2 to 7 provide a hardware implementation with multiple interfaces to securely communicate and manage telemetry data. These hardware implementations are usable in a compute platform that uses multiple chiplets to perform separate operations on behalf of different tenants, users, or customers. Some of the approaches below generally refer to the use of signatures or cryptographic key protection for telemetry data on a component basis, but such concepts can be extended to apply different types of protections or security measures of telemetry data for different tenants, users, or customers. For example, some types of telemetry data are particularly sensitive to disclosure (e.g., because the data may assist security exploits) and can be encrypted and protected from unauthorized access; whereas other types of telemetry data (e.g., that relates to system performance or billing) may only need proof of authenticity.

FIG. 2 depicts a flowchart 200 of an example process for generating certified telemetry data such as in a chiplet architecture. This process can be used for ensuring the integrity, authenticity, and trustworthiness of telemetry data collected from various hardware components within a computing platform, especially in scenarios involving discrete chiplets or components from different sources that are assembled, combined, or packaged onto a SiP/SoC or another type of chip package.

At operation 210, telemetry data is collected by telemetry monitoring circuitry from the operation of the compute platform. This telemetry data can be gathered in batches from one or multiple counters, which are typically embedded and exposed within the hardware resources of the compute circuitry of respective computing platform elements. These counters, for example, can provide various performance metrics and operational parameters, to provide raw telemetry data on an ongoing basis in response to events or monitored conditions.

At operation 220, the collected telemetry data is stored in a trusted enclave or other secure location located within (or secured and managed by) the telemetry monitoring circuitry. This enclave serves as a secure environment that protects the collected data from unauthorized access or tampering. This trusted enclave may also provide a buffer or temporary store to aggregate multiple sets or types of telemetry data, including in response to particular conditions or events.

At operation 230, a hash is generated for the telemetry data, which may be associated with a timestamp with high time precision. The hash function creates a distinct or unique digital identifier of the telemetry data and can be later used for verifying the integrity of the data. The timestamp provides a precise record of when the data was collected or produced, and can be used for correlating telemetry data with specific events or conditions (or other sets of telemetry data) occurring at some particular time or time period within the system.

At operation 240, a signature of the telemetry data hash is generated using credential provided by a trusted party (e.g., a private key provided by a manufacturer, system integrator, platform owner, tenant, or authorized user). The signature enables external components or entities to verify that specific telemetry data associated with the signature originates from a particular source and has not been modified since the signing process.

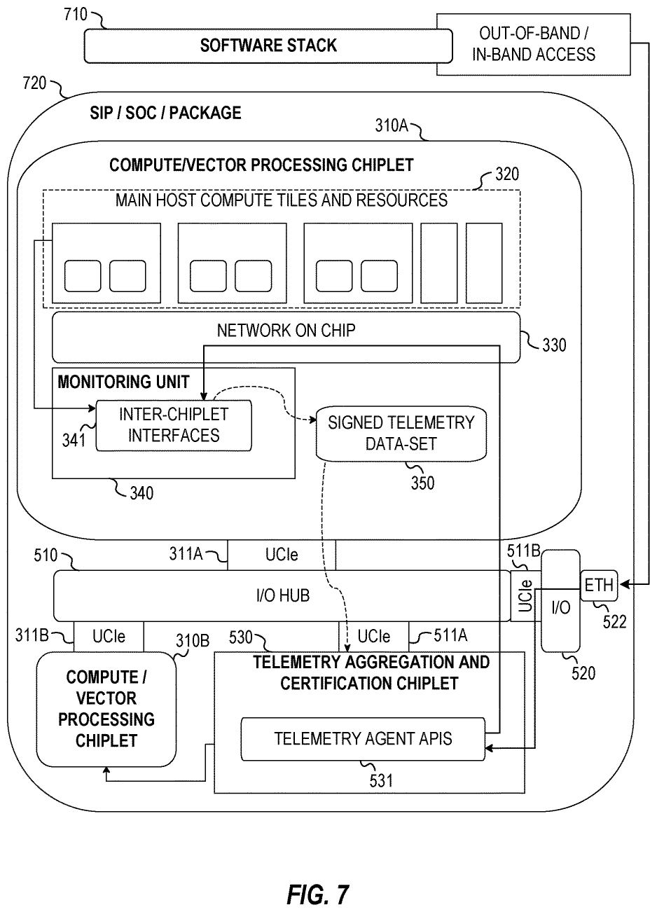

At operation 250, the telemetry data and the signature associated with the telemetry data, together also referred to as certified telemetry data, are provided to (e.g., communicated to) an external entity such as a software stack (e.g., management software stack 110, or software stack 710 discussed in FIG. 7). At operation 260, the telemetry data then undergoes validation and is then consumed, typically by an end consumer at the software stack or at a third party location. The software stack can then perform additional processing on the telemetry data, utilizing the telemetry data to make informed decisions or trigger specific actions based on analysis of the data. For example, after ensuring the telemetry data is trustworthy (e.g., by validating the signature associated telemetry data), the external entity can use the data for various applications such as auditing, monitoring, billing, compliance, or functional changes. Accordingly, the validation process confirms the integrity and authenticity of the telemetry data from the original source, allowing end consumers to rely on the information to control any number of processes and outcomes.

As will be understood, telemetry data may take the form of individual metrics, a collection of multiple metrics, or even a collection of comprehensive traces that capture sequences of observations over a time period. A trace, for example, can include several metrics recorded at multiple timestamps, encapsulating a broader picture of system activity or behavior. In such scenarios, the collection and processing of the telemetry data can include generating a signature that covers not just a single metric but a larger collection of data values. A digital signature (e.g., created by operation 240) can be applied to certify one or more collections of data values, ensuring the integrity and authenticity of related telemetry elements.

FIG. 3 depicts a chiplet configuration used in a processor architecture, showing a processing chiplet 310A (e.g., a compute processing chiplet or a vector processing chiplet) adapted for certified telemetry data collection and distribution. This figure shows how the chiplet 310A is adapted to include telemetry monitoring circuitry, implemented as a telemetry monitoring unit 340 within the chiplet, with the telemetry monitoring unit 340 being a specialized circuitry or component that is responsible to collect and establish certified telemetry data as discussed herein.

Specifically, the telemetry monitoring unit 340 may be a new component or logic block added to a chiplet—or an expansion of an existing monitoring unit of a chiplet or controller—to perform smart telemetry processing including aspects of certification and signing of telemetry data. The certified telemetry data produced by the telemetry monitoring unit 340 may be communicated to other processing chiplets or to a dedicated telemetry monitoring chiplet, such as in data communicated to a telemetry aggregation unit or logic implemented in a telemetry aggregation and certification chiplet 530 discussed with reference to FIG. 5 below. Still other implementations include integration into an I/O hub, chiplet management controller, communication or networking component, authentication or secure computing component, or the like.

In an example, the telemetry monitoring unit 340 operates as a telemetry monitoring unit and includes functional components to observe and sense telemetry data from the operation of platform resources such as one or more compute units, including the main host compute tiles and resources 320 shown in FIG. 3. In an example, the main host compute tiles and resources 320 include respective compute tiles 321A, 321B, 321C that respectively implement one or more compute cores (labeled as “C”) and cache such as L1 or L2 cache (labeled as “L1/L2”), other cache(s) accessible among multiple cores such as L3 cache 322, and other controller(s) such as memory controller 323, and the like. The resources 320 are connected to the telemetry monitoring unit 340 via a network-on-chip interface 330, such as in a scenario where the compute tile 321A provides telemetry data that can be captured and processed by the telemetry monitoring unit 340. In some examples, the network-on-chip interface 330 is provided by a fabric or interconnect that is used to communicate processing data and commands in addition to telemetry data. In other examples, a specialized or dedicated on-chip or on-package telemetry network may be used to quickly communicate telemetry data.

The telemetry monitoring unit 340 also includes one or more interfaces 341 (e.g., application programming interfaces (APIs)) that may receive telemetry data 352 from other chiplets and resources of the computing platform, including but not limited to compute (processing) resources, memory resources, power resources, storage resources, and network resources. The interfaces 341 can also be used to receive and respond to requests from external entities such as management software to request certified telemetry data or related information.

The telemetry monitoring unit 340 includes logic to store cryptographic certificates provided by trusted parties (e.g. chiplet manufacturer, system integrator, platform owner, tenant, authorized user), or like sources, within a collection of one or more chiplet certificates 342. A certificate can be added at manufacturing time or can be configured, updated, or activated out-of-band via authenticated interfaces (e.g., via one of the interfaces 341). A certificate can identify the chiplet instance itself as well as the trusted party.

The telemetry monitoring unit 340 also includes a chiplet signing logic 343 that is used to sign a particular batch or set of telemetry data 352. In an example, the chiplet signing logic 343 operates to access a current time stamp, generate a hash of the telemetry data 352, generate a signature 351 of the hash and the timestamp, and provide the signed data set (the telemetry data signature 351 and the telemetry data 352) as certified telemetry data 350 to another entity such as to the software stack.

The one or more chiplet certificates 342 and the telemetry data signature 351 can be used to validate that the data has originated from a trusted device or component, under the control of or attested as trusted by the telemetry monitoring unit 340. This telemetry data signature 351 enables other chiplets, processing units, and other internal or external entities to uniquely identify or verify the source and contents of the telemetry data 352. In further examples, multiple levels of signed telemetry may be used. For example, the telemetry monitoring unit 340 in the processing chiplet 310A could apply a first signature, while other components of the platform such as an I/O hub, BMC controller, or a telemetry aggregation and certification chiplet 530 can apply a second or subsequent signature. The generation of certification and validation at a BMC controller, for example, can enable certified telemetry to be generated and produced at a system rack level.

The telemetry monitoring unit 340 includes a temporary telemetry unit 344 to buffer and temporarily host the telemetry data 352 before creating the certified telemetry data 350 with the chiplet signing logic 343. For instance, the temporary telemetry unit 344 may buffer a telemetry data stream produced from one of the resources 320, which can be stored and managed locally in a secure location before being signed. The telemetry data signature 351 can then be generated on a hash or some other derivation of the telemetry data 352.

The telemetry monitoring unit 340, when implemented in a chiplet or other specialized, configured, or allocated circuitry, may collect telemetry data from hardware units. Such hardware units include components used by the various applications executing locally on the chiplet, such as in the chiplet's compute tiles and hardware resources (e.g., the main host compute tiles and resources 320) that provide telemetry data samples during the execution of a process on the hardware units. The telemetry data may be provided or sampled from processing cores, caches, communication or network interfaces, controllers, among other locations.

The telemetry monitoring unit 340 also includes timestamp coordination logic 345 that is used to synchronize time clocks among different entities of the compute platform, such as among different chiplets that make up the SiP, SoC, or package. A timestamp produced from the synchronized and coordinated time can be used to sign telemetry data sets that the chiplet generates for a particular consumption (e.g., certified telemetry data 350).

The telemetry monitoring unit 340 can include other elements that coordinate and provide events to activate certain types of rules or conditions across the compute platform, such as rules that are registered by the management software stack (e.g., with a software stack 710, discussed with reference to FIG. 7) or indicated by a multi-chiplet unit (e.g., with the telemetry aggregation and certification chiplet 530, discussed with reference to FIG. 5). Coordination logic can be used to coordinate operations related to telemetry such as monitoring, event detection, rules, conditions, and data broadcasts, within the chiplet itself (e.g., with intra-chiplet coordination) or with multiple other chiplets of the compute platform (e.g., with inter-chiplet coordination, inter-platform coordination, etc.).

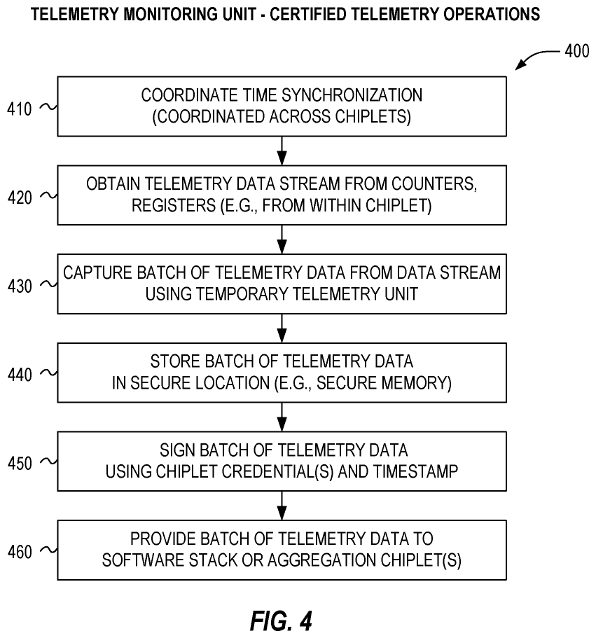

FIG. 4 depicts a flowchart 400 with a simplified overview of operations for certified telemetry data collection and distribution, such as with the telemetry monitoring unit 340 operating as telemetry monitoring circuitry in a respective chiplet, or with similar components in other chiplets or processing circuitry. It will be understood that more complex analyses and processes may be combined or substituted with these operations. Additionally, although this flowchart 400 depicts operations to perform the capture or retrieval of telemetry data, corresponding operations can be triggered based on notifications or events (e.g., telemetry data events that are identified and broadcast, or that are notified from the software stack).

At operation 410, the telemetry monitoring unit 340 coordinates time synchronization across multiple chiplets, packages, and/or timing domains. This operation ensures that telemetry data collected from various chiplets within the computing platform is timestamped and tracked consistently and accurately, particularly for telemetry data that includes some relevant measurement of time. Time synchronization may utilize existing protocols, such as Time-Sensitive Networking (TSN), to maintain time coherence across different components of a platform (e.g., a platform that includes multiple chiplets).

At operation 420, the telemetry monitoring unit 340 obtains a telemetry data stream from counters, registers, or other elements provided by the chiplet (e.g., processing chiplet 310A). These elements provide real-time data including but not limited to performance metrics, operational parameters, resource consumption and resource utilization metrics, element conditions, and the like. This real-time telemetry data stream serves as a raw input for subsequent processing and certification.

At operation 430, the telemetry monitoring unit 340 captures a batch of telemetry data from the data stream using a temporary telemetry unit 344. This batching process collects the telemetry data into manageable data sets, facilitating efficient storage, verification and signing, and transmission. The temporary telemetry unit 344 functions as an intermediary buffer for the telemetry data, before the telemetry data is communicated to other entities for further processing.

At operation 440, the telemetry monitoring unit 340 stores the batch of telemetry data, also referred to as telemetry data set, in a secure location, such as secure memory in the processing chiplet 310A or the compute package, high-bandwidth memory (HBM) accessible to the processing chiplet 310A or the compute package, or the like. This secure storage ensures that the telemetry data remains protected from unauthorized access or tampering before and during the certification process.

At operation 450, the telemetry monitoring unit 340 signs the batch of telemetry data using one or more chiplet credentials and a timestamp. In one example, the signing process involves generating a cryptographic signature that can be used to identify the source of the telemetry data and verify its authenticity. The timestamp, synchronized in operation 410, can be included in the signature to provide temporal context for the telemetry data, including for telemetry data that does not have time information. As noted above, the chiplet certificates used for validating the signature and the credentials used for establishing the signature can be provisioned during manufacturing or via authenticated interfaces.

At operation 460, the telemetry monitoring unit 340 provides the signed batch of telemetry data to a software stack (e.g., software stack 710 as shown in FIG. 7) or to a telemetry aggregation and certification chiplet (e.g., chiplet 530 as shown in FIG. 5). The software stack may use the certified telemetry data for various purposes, such as performance monitoring, resource allocation, or compliance verification. Alternatively, a telemetry aggregation and certification chiplet (e.g., chiplet 530 as shown in FIG. 5) can consolidate telemetry data from multiple chiplets to generate a platform-wide or system-wide source of certified telemetry data, before providing the certified telemetry data to the software stack or another destination.

FIG. 5 depicts an example configuration of a telemetry aggregation and certification chiplet 530, which in the depicted example is implemented as a separate chiplet and connected to multiple processing chiplets of the computing platform. In this role, the telemetry aggregation and certification chiplet 530 operates as a multi-chiplet telemetry monitoring unit. For instance, the telemetry aggregation and certification chiplet 530 may be connected to processing chiplet 310B (connected via UCIe interface 311B), processing chiplet 310A (not shown, connected via UCIe interface 311A), and the like, via an I/O Hub 510. The I/O Hub 510 may utilize the UCIe protocol and a UCIe interface 511A to connect the telemetry aggregation and certification chiplet 530 to the other chiplets and a network interface, such as an Ethernet interface 522 provided via I/O 520 and UCIe interface 511B. Other interconnects, interfaces, and protocols may be used, including interfaces or communication buses (or dedicated lanes and bandwidth on these interfaces or buses) specialized for the communication of telemetry data. Thus, it will be understood that telemetry data and related telemetry events or commands can also be communicated via a non-UCIe interface.

The telemetry aggregation and certification chiplet 530 coordinates telemetry data collection and verification for the various processing chiplets of the compute platform. In some examples, the telemetry aggregation and certification chiplet 530 may collect separately signed sets of certified telemetry data (e.g., from different chiplets or resources), to aggregate this certified telemetry data into a larger package and set of trusted certified telemetry data.

The telemetry aggregation and certification chiplet 530 includes various interfaces and logic to obtain, aggregate, and certify telemetry data collected from among multiple chiplets, including chiplets that provide certified and encrypted telemetry data. This may include interfaces 531 (e.g., APIs) that receive and communicate certified telemetry data with management software (e.g., a software stack 710 discussed in FIG. 7).

The telemetry aggregation and certification chiplet 530 includes chiplet telemetry validation logic 534 to validate (and in some examples, unencrypt) telemetry data provided by individual chiplets or sources, including based on information stored in a chip certificate. Upon validation, chip signing logic 533 can apply a credential (e.g., private key) associated with the chip certificate 532 (or another set of certificates) to generate a signature for a hash of the telemetry data, thus producing certified telemetry data. The certified telemetry data, before or after signature, can be stored in a database or memory such as a telemetry data aggregator store 536. In some examples, if telemetry data is not validated, then the telemetry data may be rejected, flagged, or stored separately (e.g., isolated).

The chip signing logic 533 can establish signed telemetry data and verify signed telemetry data in connection with a mapping table 550 that associates a chiplet (or other source), a certificate owner, and a certificate. For instance, a particular identifier of a chiplet (Ox1), owner name, and certificate data may be stored as a data entry in the mapping table 550, and used to verify that signed data provided from that particular chiplet is valid and not tampered with. Other data characteristics can be tracked to assist the processing and validation of relevant telemetry data and data signatures with particular sources.

The telemetry aggregation and certification chiplet 530 also includes timestamp coordination logic 535 to coordinate time clocks used in creating and distributing the certified telemetry data. This timestamp coordination logic 535 may operate in similar fashion as timestamp coordination logic 345, or the timestamp coordination logic 535 may operate as a time controller for other telemetry monitoring circuitry (e.g., to control time synchronization among other devices including other processing chiplets).

In further examples, the credential (e.g., private key) may be updatable via an out-of-band process, via firmware changes, or via another after-manufacture process. For example, the credential may be provided when a chiplet is provided by a first entity (e.g., a chiplet manufacturer or supplier) but is integrated by a second entity (e.g., a package integrator who designs and manufactures the SoC/SiP). In this case, the second entity may want to certify the telemetry. Thus, various post-manufacturing mechanisms may be provided and used to identify and update keys, certificates, and other credential elements.

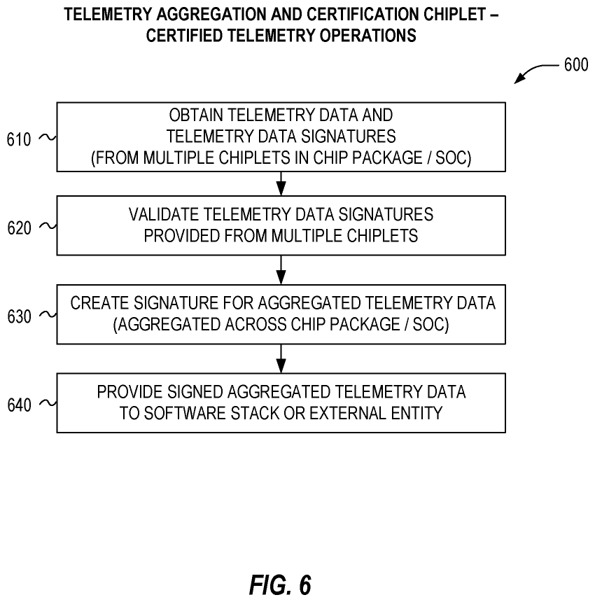

FIG. 6 depicts a flowchart 600 of a simplified overview of operations for certified telemetry data collection and distribution, such as with the telemetry aggregation and certification chiplet 530 operating as telemetry monitoring circuitry in a standalone chiplet, or with similar components provided by other chiplets or processing circuitry. It will be understood that additional certification and verification operations, such as the certification and verification of compute data values, memory data values, network data values, security information, etc., may be provided in connection with these telemetry aggregation operations and functions.

At operation 610, actions are performed by the telemetry aggregation and certification chiplet 530 to obtain/aggregate telemetry events and data from among different chiplets of the package (e.g., chiplets such as processing chiplet 310A, processing chiplet 310B, etc. located throughout the SoC or SoP/SiP) or platform (e.g., from chiplets located among multiple packages or chip assemblies in a coordinated compute platform). Various APIs may be used to coordinate (e.g., subscribe, notify) the telemetry events and data among the respective chiplets, while the communications used to provide the events and data may be performed using a chiplet-to-chiplet or die-to-die data communication protocol (e.g., a protocol performed according to a Universal Chiplet Interconnect Express (UCIe) standard, or using specialized protocols for the communication of telemetry data and events).

In some examples, at operation 610, certified telemetry data and telemetry data signatures are obtained from multiple chiplets within the chip package or SoC to be aggregated and verified into larger sets of certified telemetry data. For instance, each of the multiple chiplets may provide telemetry data related to performance, resource usage, or other operational metrics, as a respective chiplet individually signs this telemetry data using a certificate unique to the respective chiplet (e.g., as detailed in the flowchart 400 of FIG. 4). The telemetry aggregation and certification chiplet 530 collects the certified telemetry data from among multiple chiplets, validating the data is securely transmitted, valid, and properly linked to the corresponding source.

At operation 620, the telemetry aggregation and certification chiplet 530 verifies the telemetry data signatures provided by the multiple chiplets for the various sets of telemetry data. This validation process involves verifying the authenticity of the signatures using the chiplet certificates, which are typically provisioned during manufacturing or provided through authenticated interfaces. In some examples, if the telemetry data signatures are not verified, then the telemetry aggregation and certification chiplet 530 may reject, flag or isolate selected telemetry data sets received from one or more of the multiple chiplets.

At operation 630, the telemetry aggregation and certification chiplet creates a signature for an aggregated set of the validated telemetry data. This aggregated data represents a consolidated view of the telemetry collected from multiple chiplets (and in some cases, all chiplets, processing units, etc.) within the chip package or SiP/SoC, for a defined or limited period of time, for a particular tenant or user, or for a particular operational condition. Aggregated telemetry data therefore may provide different combinations or amounts of data that matches a dimension of interest, such as based on the time (e.g., collected over an hour or day), tenant or user (e.g., involving the execution of an operation from a particular tenant), or operational condition (e.g., involving the operations of a particular service executing in hardware). The signature can be generated using a package-level or SoC-level credential, which attests to the authenticity and integrity of the aggregated telemetry data. This signature, also referred to as an aggregated telemetry data signature, provides a unified and certified representation of the telemetry data on behalf of the entire chip package or SoC.

At operation 640, the signed aggregated telemetry data is provided as certified telemetry data to the software stack or another external entity such as a management system. Such entities may use the certified telemetry data for various purposes, such as performance monitoring, resource allocation, billing, compliance verification, or decisions related to safety-sensitive operations, as discussed above.

FIG. 7 provides a simplified architectural overview of an integrated compute platform 720 (e.g., embodied by a SiP, SoC, or Package), showing how the elements of FIG. 3 and FIG. 5 including a telemetry monitoring unit 340 and a telemetry aggregation and certification chiplet 530 can be integrated into a computing system. Here, this architectural overview depicts multiple processing chiplets such as processing chiplet 310A and processing chiplet 310B connected to the telemetry aggregation and certification chiplet 530, as the telemetry agent interfaces 531 collect telemetry data and events from the various monitoring units (e.g., from the interfaces 341). The telemetry aggregation and certification chiplet 530 also receives out-of-band and in-band communications from the software stack 710 related to system conditions, events, and optimizations related to telemetry data collection and processing. In some examples, the telemetry aggregation and certification chiplet 530 can provide commands to the various monitoring units of the processing chiplets, to coordinate applied rules and mitigations, and to cause the collection of additional telemetry data on behalf of particular tenants, users, or entities.

Additional collections and communications of certified telemetry data may be coordinated based on a hierarchy of coordination among the telemetry monitoring unit 340, the telemetry aggregation and certification chiplet 530, and other peers at higher layers or levels. Thus, the techniques discussed herein can be used to certify telemetry data provided not only for chiplets within a discrete package, but among packages and platforms, groups of platforms and devices, and other organizational groups (as scaled to larger systems, data center racks and blades, etc.).

Telemetry data may be encompassed by a variety of definitions and standards, and is not limited to the particular formats or types discussed above. In some examples, each chiplet or device provider may have different metrics and telemetry data definitions for the same properties, which may be coordinated in connection with certified telemetry collection. In other settings, standards bodies may define particular metrics applicable to wider industry usage, such as metrics provided with the OpenTelemetry standard (provided by the Cloud Native Computing Foundation) or other standards bodies and industry consortiums. Standards bodies may also define power metrics associated with compute elements, thermal metrics, and other properties in a generic way, but using very specific semantics and units (e.g., watts, etc.).

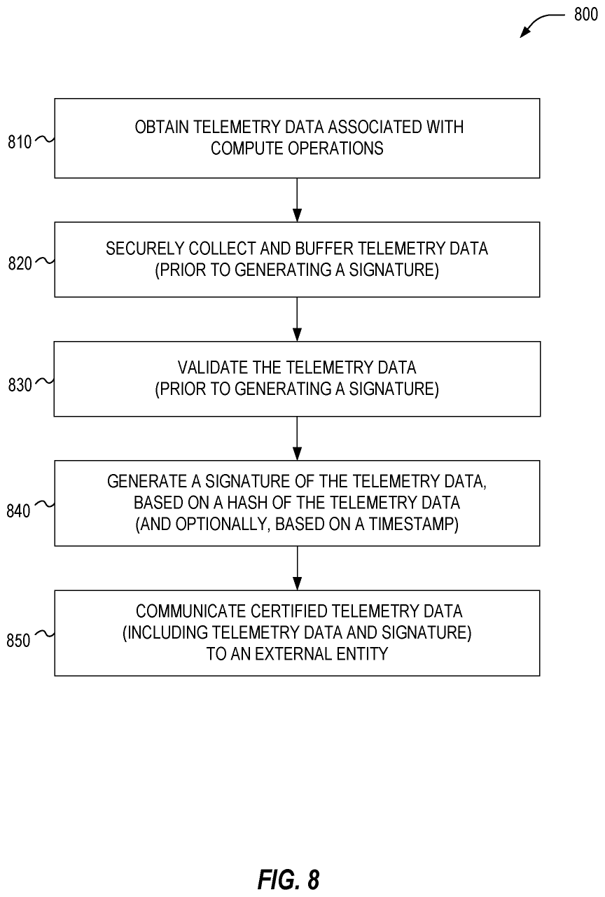

FIG. 8 depicts a flowchart 800 of an example method of generating certified telemetry data in a compute platform, such as configured or performed in a compute platform implemented with processing circuitry hardware (e.g., integrated compute platform 720 embodied by a SiP, SoC, or Package) that includes compute circuitry (e.g., compute tiles and resources 320) and telemetry monitoring circuitry (e.g., telemetry monitoring unit 340 or telemetry aggregation and certification chiplet 530 implemented as telemetry monitoring circuitry etc.). Other implementations of compute platforms and processing circuitry hardware are discussed below with reference to FIGS. 9, 10A, 10B, and 11.

At operation 810, telemetry data associated with various compute operations (or, related operations in a compute platform) is obtained (e.g., received or retrieved). This telemetry data may include performance metrics, operational parameters, or other relevant data generated by hardware resources during or in connection with the compute operations performed in the compute platform. The telemetry data may be provided from a compute processing resource (e.g., within a processing chiplet), or from other related resources associated with the compute operations (e.g., from network, storage, or memory resources).

At operation 820, the telemetry data is securely collected and buffered prior to generating a signature. This maintains the telemetry data temporarily in a secure environment, such as in a trusted enclave or secure memory, to prevent unauthorized access or tampering. In an example, the telemetry data is collected with a temporary telemetry unit that is configured to securely buffer the telemetry data prior to generating the signature.

At operation 830, the telemetry data is validated prior to generating a signature. This validation process may involve verifying the integrity and consistency of the telemetry data (e.g., based on trusted party certificates or attestation data) to ensure the data is accurate and reliable for subsequent certification. In scenarios where the operations of the flowchart 800 are performed by a multi-chiplet telemetry monitoring unit (e.g., as shown in FIG. 5), this validation may be performed on telemetry data sets received from the multiple chiplets, based on success to verify respective telemetry data signatures provided for the telemetry data sets. This validation may also involve rejecting selected telemetry data sets received from one or more of the multiple chiplets, based on failure to verify respective telemetry data signatures provided for the selected telemetry data sets.

At operation 840, a signature of the telemetry data is generated. The signature can be based on a hash of the telemetry data and may optionally include a timestamp to provide temporal context. The signature can be used by a receiving entity to authenticate and verify the certified telemetry data as untampered and originating from a trusted source. In some examples, this hash and/or this signature is generated by the telemetry monitoring circuitry. For example, the signature may be generated based on a credential stored in the telemetry monitoring circuitry by a trusted party (e.g., manufacturer) associated with the telemetry monitoring circuitry.

At operation 850, the certified telemetry data, including the telemetry data and the associated signature, is communicated to an external entity. This external entity may include a software stack 710, management system, or other destination that makes use of the certified telemetry data for monitoring, analysis, or decision-making purposes.

Additional operations (not depicted in FIG. 8) may include specific operations performed by the telemetry monitoring circuitry when implemented as a monitoring unit inside a chiplet, for a chiplet that includes the monitoring unit and the hardware resource (e.g., as depicted in FIG. 3, including operations as depicted in FIG. 4). Other specific operations may be performed by the telemetry monitoring circuitry when implemented as a multi-chiplet telemetry monitoring unit in a first (standalone) chiplet to aggregate and certify telemetry data from the hardware resources of multiple chiplets (e.g., as depicted in FIG. 5, including operations as depicted in FIG. 6). Still other related operations may be performed by the telemetry monitoring circuitry when implemented in an I/O hub, BMC, network processing unit, or controller.

FIGS. 9, 10A, 10B, and 11 respectively depict simplified aspects of example computing architectures in which any of the techniques and configurations above may be implemented. It will be understood that the elements described above for telemetry monitoring and events may be integrated for use with various forms of the following hardware components, including for obtaining telemetry data from a variety of the following elements.

FIG. 9 depicts an example hardware arrangement of a data center 900 used to provide multiple implementations or instances of a computing system (e.g., computing system 1100, discussed below), with each instance of the computing system being identified as a respective platform (e.g., platform 930). The data center 900 includes data center infrastructure 901, a data center network fabric 902, and a power distribution unit 903 to support multiple racks of compute platforms, with a single instance of a rack 910 depicted. The data center infrastructure 901 may provide physical components that host the compute platform hardware, storage components, and networking equipment; the data center network fabric 902 may include switches and networking components to support data flows among various compute platforms and storage devices throughout the data center; and the power distribution unit 903 may include components to distribute and control power among the various compute platforms, networking, and storage devices.

The rack 910 includes but is not limited to cooling infrastructure 911, a network interface 912, and related physical components (not shown) to support discrete instances of multiple chassis. The rack 910 provides power, connectivity, and cooling to each of the multiple chassis in a single rack, with a single instance of a chassis 920 depicted in FIG. 9. The chassis 920 includes but is not limited to cooling infrastructure 921, a chassis network fabric 922, and a power supply 923, which provides cooling, network connectivity, and power to multiple platforms within the chassis, with a single instance of a platform 930 depicted in FIG. 9. It will be understood that a common data center rack configuration may include dozens of chassis, with each chassis adapted to support a number of platforms depending on the physical size of the platform hardware and supporting equipment.

The platform 930 in some implementations may be referred to as a server or node, depending on the use case for the platform 930 and the data center 900. The platform 930 includes but is not limited to implementations of a discrete computing system hosted on a single board. The platform 930 is depicted as hosting a chip assembly 940A and chip assembly 940B on a first board provided by a printed circuitry board (PCB) or other platform board, shown as PCB 931. In some examples, the platform 930 may include only one chip package, whereas the PCB 931 depicts interconnection of multiple chip assemblies via a device-to-device interface (e.g., a PCI express (PCIe) or compute express link (CXL) interface). Additional chip packages and components (not shown) may also be hosted on the PCB 931.

Some implementations of the chip assembly 940A and 940B may be termed as a System-on-Chip (SoC) package, as modular chiplets that perform different functions are integrated into a single package—even though this chip package is composed of multiple dies unlike a traditional SoC design that uses a single die. Other implementations of the chip assembly 940A and 940B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

As used herein, a chiplet is defined to be any integrated circuit (IC) designed to perform one or more specific functions in a modular structure including interface circuitry to connect the chiplet to an interposer or other interconnect structure to permit communication between the chiplet and one or more other chiplets via one or more standardized protocols to form a system. Unlike monolithic systems implemented with circuitry on a single substrate such as some general-purpose microprocessors, systems implemented with chiplets are modular and may include chiplets from one manufacturer or from multiple different manufacturers.

The chip assembly 940A and chip assembly 940B are each packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of chip assembly 940A is depicted as including a I/O Hub chiplet 941, chiplets 942, and a power supply 943. These components may be hosted on an interposer that is designed to connect multiple dies or components within a single semiconductor package (e.g., chip package). In some examples, the chiplets 942 may be manufactured and sourced separately and later assembled into the chip package to create the chip assembly 940A. Various connections may be provided among the chiplets 942 such as with the use of Universal Chiplet Interconnect Express (UCIe) or similar chiplet-to-chiplet interfaces and interconnects (e.g. Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced eXtensible Interface (AXI), and certain implementations of PCIe, CXL, etc.).

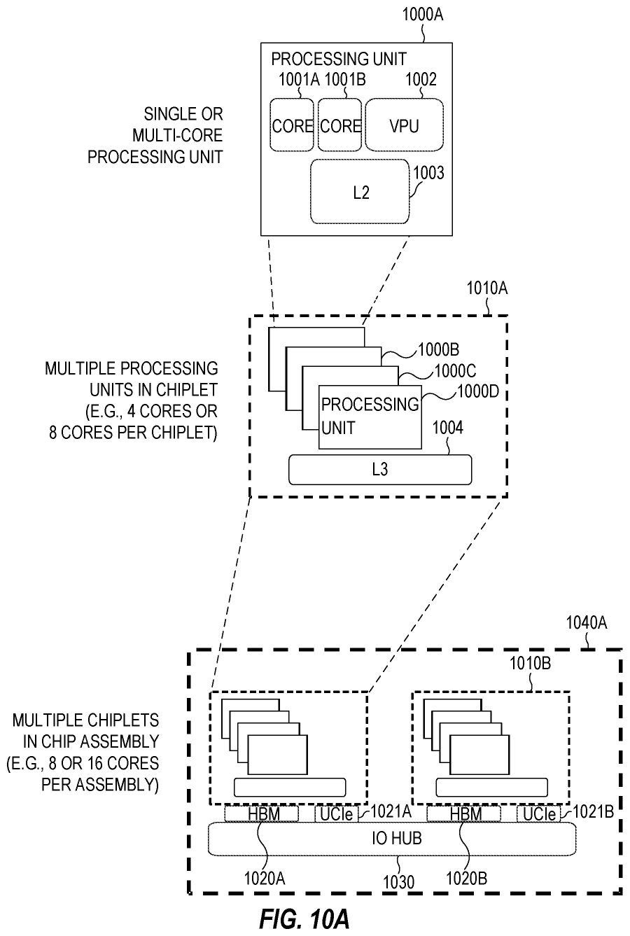

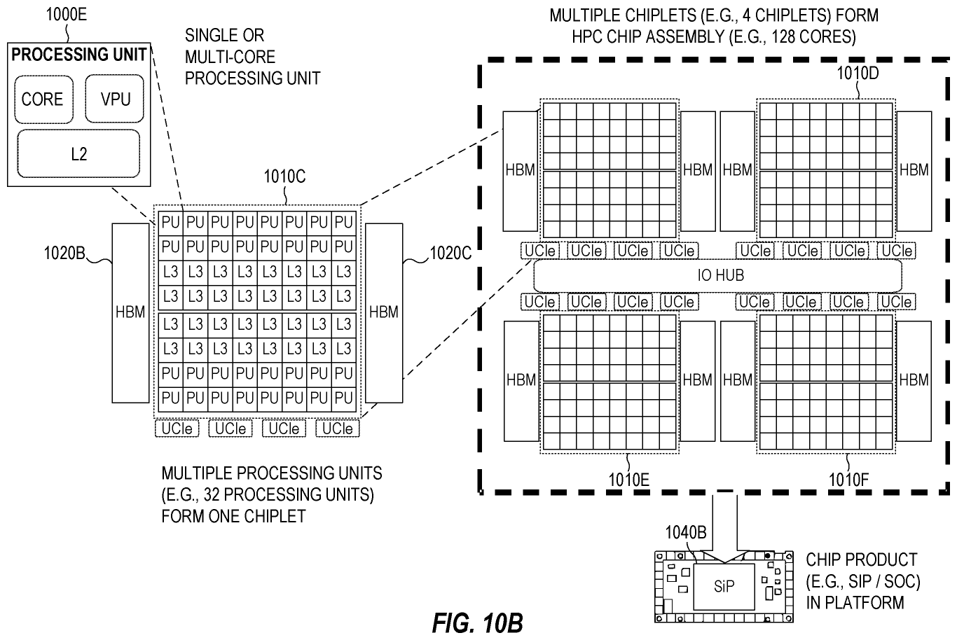

FIG. 10A depicts an example arrangement of a chip assembly 1040A (e.g., a multi-processing core implementation of chip assembly 940A or 940B), with expanded views of the chiplets and processing units included therein. This arrangement shows how the chip assembly 1040A, which may constitute a SoC, SoP, SiP, or other type of chip package, is composed from chiplets such as chiplet 1010A, chiplet 1010B, etc. and associated on-package memory (e.g., high-speed memory) such as 3D-stacked, HBM instances shown as HBM 1020A, HBM 1020B, interfaces (e.g., UCIe interfaces) shown as UCIe 1021A, UCIe 1021B, and I/O hub 1030 (e.g., which may be implemented by a I/O chiplet). Other hardware elements of a chip package are not depicted for simplicity.

Each chiplet includes multiple processing units and each processing unit includes one or multiple cores. For instance, chiplet 1010A as depicted includes four processing units (processing unit 1000A, processing unit 1000B, processing unit 1000C, and processing unit 1000D) and an L3 cache 1004. Each processing unit may include one or multiple processing cores, one or multiple caches, and optionally other processing units or elements. For instance, processing unit 1000A is depicted as including two cores (core 1001A and core 1001B), vector processing unit 1002, and an L2 cache 1003. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC) and packet switched communications, and the like.

FIG. 10B depicts an example arrangement of a chip assembly 1040B (e.g., a multi-chiplet high-performance computing (HPC) implementation of chip assembly 940A, 940B), adapted for HPC applications (e.g., parallel processing operations involving thousands, millions, or more of processors or cores operating simultaneously). The example chip assembly 1040B depicts placement as a SiP, SoC, or other package onto a platform board (e.g., PCB 931), and optionally in a data center (e.g., data center 900) or in a standalone deployment setting (e.g., in a standalone computer system, mobile computing device, autonomous device, etc.).

The chip assembly 1040B is composed of multiple chiplets, shown with four chiplets, chiplet 1010C, chiplet 1010D, chiplet 1010E, chiplet 1010F. Each chiplet includes multiple processing units, such as 32 processing units with a corresponding L3 cache for each processing unit. Each processing unit may include one or multiple cores, such as a single-core processing unit 1000E shown as part of chiplet 1010C. The chip assembly 1040B is also composed of corresponding memory resources, such as HBM elements corresponding to respective banks of processing units (e.g., HBM 1020B and HBM 1020C corresponding respective sets of processing units of chiplet 1010C), UCIe interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configure the computing system and implementing hardware (e.g., the processing unit 1000, chiplet 1010, chip 940, platform 930) to perform steps and operations described above for electronic systems or devices (e.g., to perform telemetry data collection, processing, eventing, etc. using the telemetry monitoring unit 340 or the telemetry aggregation and certification chiplet 530, etc.). It should be further understood that software including one or more computer-executable instructions that facilitate processing and operations as described above may be distributed, installed, or otherwise provided with networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

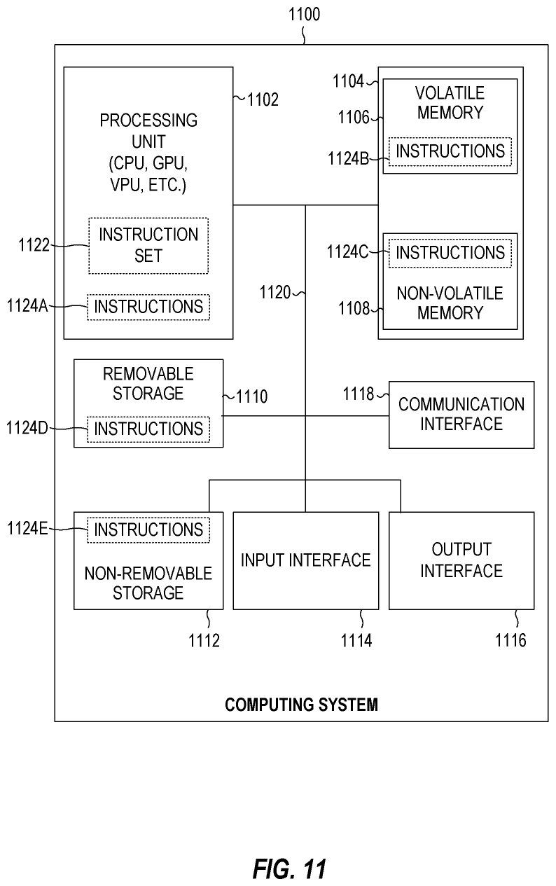

FIG. 11 depicts a block diagram of an example computing system 1100 (e.g., device, apparatus, machine, etc.) that may be programmed into a special purpose machine suitable for implementing one or more embodiments for telemetry data capture, analysis, monitoring, processing, communication, eventing, learning, or like aspects disclosed herein. For instance, the compute circuitry, telemetry monitoring circuitry, chiplet circuitry, or other compute sub-components described above may be embodied by the computing system 1100, such as in the form of a computer or specialized electronic device that includes sufficient processing power, memory resources, and communications throughput capability to perform operations consistent with the examples herein.

The computing system 1100 may include at least one hardware processing unit 1102 such as a central processing unit (CPU), a graphics processing unit (GPU), a vector processing unit (VPU), a neural processing unit (NPU), a hardware accelerator, or combinations or variants thereof. The at least one hardware processing unit 1102 is an implementation of processor circuitry and may be embodied by various types of chip assemblies, products, or packages as discussed with reference to FIGS. 9 to 10B. Circuitry (e.g., processing circuitry) as used herein is a collection of circuits implemented in tangible entities of the computing system 1100 that include hardware (e.g., simple circuits, gates, logic, etc.). Circuitry membership may be flexible over time. Circuitries include members that may, alone or in combination, perform specified operations when operating. In some examples, hardware of the circuitry may be immutably designed to carry out a specific operation (e.g., hardwired).

In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The computing system 1100 may also include at least one memory device 1104 such as volatile memory 1106 and non-volatile memory 1108, and at least one storage device such as removable storage 1110 and/or non-removable storage 1112 such as a drive unit, some or all of which may communicate with each other via an interconnect, fabric, link, or bus 1120.

The computing system 1100 may include an output interface 1116 such as an interface connected to a display device, and an input interface 1114 such as an interface connected to an alphanumeric input device or a user interface (UI) navigation device. In some examples, a connected I/O device may also include a display device, alphanumeric input device, and navigation device that is integrated into a single unit such as a touch screen display.

The computing system 1100 may additionally include a communication interface 1118, such as for connection with a network interface device used to transmit and receive electronic signals on a network. The computing system 1100 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices such as the volatile memory 1106, the non-volatile memory 1108, the removable storage 1110, or the non-removable storage 1112 may provide a machine-readable medium. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1124 with respective implementations of instructions 1124A, 1124B, 1124C, 1124D, and 1124E.

The instructions 1124 may reside, during execution or other operation of the computing system 1100, completely or at least partially within the volatile memory 1106 as instructions 1124B, within non-volatile memory 1108 as instructions 1124C, within removable storage as instructions 1124D, within non-removable storage as instructions 1124E, or within the hardware processing unit 1102 as instructions 1124A. Thus, any combination of the hardware processing unit 1102, the volatile memory 1106, the non-volatile memory 1108, or a storage device of the removable storage 1110 or non-removable storage 1112 may constitute a machine-readable medium or media. The instructions 1124A, when loaded and executed by the hardware processing unit 1102, may invoke or utilize a defined instruction set 1122 of the hardware processing unit 1102, such as a processor instruction set defined by an instruction set architecture (ISA) of a reduced instruction set computer (RISC) or complex instruction set computer (CISC) architecture—including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 1102) discussed herein.

The term “machine readable medium” may include any medium that is capable of storing, encoding, or carrying instructions for execution by components or the whole of the computing system 1100 (or a similar machine) and that cause the computing system 1100 or its components to perform any one or more of the techniques or functions described herein, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 1124 may further be transmitted or received over a communications network using a transmission medium via the communication interface 1118 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P 2P) networks, among others.

Method examples or other operations described herein can be implemented in part or in whole by the aforementioned machines, platforms, or devices, or related systems (including computer, robotic, and autonomous systems). The components of the illustrative devices, systems, and methods employed may be implemented in various examples by digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.

Computer-readable instructions can be provided as processor instructions, interpreter instructions, or other types of directives, prompts, scripts, macros, templates, code injection annotations, or other data that are directly executed (e.g., on hardware, in an interpreter, virtual machine, etc.) compiled, assembled, combined, interpreted, obfuscated, compressed, encrypted, transpiled, or modified before the execution by processing circuitry. The computer-readable instructions may be decrypted, uncompressed, unpacked, or adapted prior to execution. Thus, computer-readable instructions encompass information that is provided in executable form (e.g., object code or binary executable code), information that is used to create an executable form of code, or information that is used to derive or create intermediate information used in connection with creation, distribution, or the execution of code. Computer-readable instructions may be provided not just from a single medium or computer system, but from multiple sources including remote networked sources.

Additional examples of the presently described embodiments include the following, non-limiting implementations. Each of the following non-limiting examples may stand on its own or may be combined in any permutation or combination with any one or more of the other examples provided below or throughout the present disclosure.

Example 1 is processing circuitry, comprising: compute circuitry, the compute circuitry comprising hardware resources configured to perform compute operations in a platform; and telemetry monitoring circuitry configured to: obtain telemetry data from the hardware resources, the telemetry data produced from the compute operations performed in the platform; generate a signature of the telemetry data, based on a hash of the telemetry data; and communicate certified telemetry data from the processing circuitry to an external entity, the certified telemetry data including the telemetry data and the signature of the telemetry data.

In Example 2, the subject matter of Example 1 optionally includes wherein the telemetry monitoring circuitry is configured to generate the hash of the telemetry data.

In Example 3, the subject matter of any one or more of Examples 1-2 optionally include wherein the telemetry monitoring circuitry is configured to generate the signature based on a timestamp associated with the telemetry data.

In Example 4, the subject matter of Example 3 optionally includes wherein the telemetry monitoring circuitry is configured to perform time synchronization among a plurality of hardware resources of the processing circuitry to synchronize the timestamp, prior to generation of the signature.

In Example 5, the subject matter of any one or more of Examples 1-4 optionally include wherein the telemetry monitoring circuitry is configured to generate the signature based on a credential stored in the telemetry monitoring circuitry by a trusted party (e.g., manufacturer) associated with the telemetry monitoring circuitry.

In Example 6, the subject matter of any one or more of Examples 1-5 optionally include wherein the telemetry monitoring circuitry includes a temporary telemetry unit configured to securely buffer the telemetry data prior to generating the signature.

In Example 7, the subject matter of any one or more of Examples 1-6 optionally include wherein the telemetry monitoring circuitry is configured as a monitoring unit inside a chiplet, and wherein the chiplet includes the monitoring unit and the hardware resources.

In Example 8, the subject matter of Example 7 optionally includes wherein the monitoring unit includes at least one interface to receive telemetry data events from the hardware resources within the chiplet.

In Example 9, the subject matter of any one or more of Examples 1-8 optionally include wherein the telemetry monitoring circuitry is configured as a multi-chiplet telemetry monitoring unit in a first chiplet to aggregate and certify telemetry data from the hardware resources of multiple chiplets, and wherein the multi-chiplet telemetry monitoring unit is configured to: validate telemetry data sets received from the multiple chiplets, based on success to verify respective telemetry data signatures provided for the telemetry data sets; aggregate the validated telemetry data sets; and generate an aggregated telemetry data signature based on at least one hash produced from the aggregated telemetry data sets.

In Example 10, the subject matter of Example 9 optionally includes wherein the multi-chiplet telemetry monitoring unit is configured to validate the respective telemetry data signatures based on a mapping between the multiple chiplets and certificate information corresponding to the multiple chiplets, wherein the mapping is provided in a mapping table that tracks chiplet information, certificate owner information, and certificate data, for a respective chiplet of the multiple chiplets.

In Example 11, the subject matter of any one or more of Examples 9-10 optionally include wherein the multi-chiplet telemetry monitoring unit is configured to reject selected telemetry data sets received from one or more of the multiple chiplets, based on failure to verify respective telemetry data signatures provided for the selected telemetry data sets.

In Example 12, the subject matter of any one or more of Examples 9-11 optionally include wherein the multi-chiplet telemetry monitoring unit further comprises timestamp coordination logic configured to synchronize time across the multiple chiplets.

In Example 13, the subject matter of any one or more of Examples 9-12 optionally include wherein the multi-chiplet telemetry monitoring unit includes at least one interface to receive telemetry data events from the hardware resources of the multiple chiplets.

In Example 14, the subject matter of any one or more of Examples 1-13 optionally include wherein the hardware resources to perform the compute operations comprise a plurality of compute tiles, and wherein each compute tile comprises at least one processor core and at least one cache associated with the at least one processor core.

In Example 15, the subject matter of any one or more of Examples 1-14 optionally include wherein the compute circuitry and the telemetry monitoring circuitry are implemented in a processing chiplet, and wherein the processing chiplet is configured to connect to at least one other chiplet via an interconnect.

In Example 16, the subject matter of Example 15 optionally includes wherein the telemetry data is received via the interconnect using a data communication protocol, wherein the data communication protocol operates in accordance with a Universal Chiplet Interconnect Express (UCIe) standard.

Example 17 is a machine-readable medium including instructions, which when executed by processing circuitry, configures the processing circuitry according to any of Examples 1 to 16.

Example 18 is a method for telemetry monitoring, comprising operations to configure the processing circuitry according to any of Examples 1 to 16.

Example 19 is a method performed by telemetry monitoring circuitry, comprising: obtaining telemetry data from a compute platform, the telemetry data produced from compute operations performed in one or more hardware resources of the compute platform; generating a signature of the telemetry data, based on a hash of the telemetry data; and communicating certified telemetry data to an external entity, the certified telemetry data including the telemetry data and the signature of the telemetry data.

In Example 20, the subject matter of Example 19 optionally includes generating the hash of the telemetry data.

In Example 21, the subject matter of any one or more of Examples 19-20 optionally include generating the signature based on a timestamp associated with the telemetry data.

In Example 22, the subject matter of Example 21 optionally includes performing time synchronization among a plurality of hardware resources of the compute platform to synchronize the timestamp, prior to generating the signature.

In Example 23, the subject matter of any one or more of Examples 19-22 optionally include wherein the telemetry monitoring circuitry is configured to generate the signature based on a credential stored in the telemetry monitoring circuitry by a trusted party (e.g., manufacturer) associated with the telemetry monitoring circuitry.

In Example 24, the subject matter of any one or more of Examples 19-23 optionally include wherein the telemetry monitoring circuitry includes a temporary telemetry unit configured to securely buffer the telemetry data prior to generating the signature.

In Example 25, the subject matter of any one or more of Examples 19-24 optionally include wherein the telemetry monitoring circuitry is configured as a monitoring unit inside a chiplet, and wherein the chiplet includes the monitoring unit and the one or more hardware resources.

In Example 26, the subject matter of Example 25 optionally includes wherein the monitoring unit includes at least one interface to receive telemetry data events from the hardware resources within the chiplet.

In Example 27, the subject matter of any one or more of Examples 19-26 optionally include wherein the telemetry monitoring circuitry is configured as a multi-chiplet telemetry monitoring unit in a first chiplet to aggregate and certify telemetry data from the one or more hardware resources located among multiple chiplets, and wherein the method further comprises: validating telemetry data sets received from the multiple chiplets, based on success to verify respective telemetry data signatures provided for the telemetry data sets; aggregating the validated telemetry data sets; and generating an aggregated telemetry data signature based on at least one hash produced from the aggregated telemetry data sets.

In Example 28, the subject matter of Example 27 optionally includes wherein the multi-chiplet telemetry monitoring unit validates the respective telemetry data signatures based on a mapping between the multiple chiplets and certificate information corresponding to the multiple chiplets, wherein the mapping is provided in a mapping table that tracks chiplet information, certificate owner information, and certificate data, for a respective chiplet of the multiple chiplets.

In Example 29, the subject matter of any one or more of Examples 27-28 optionally include wherein the method further comprises: rejecting selected telemetry data sets received from one or more of the multiple chiplets, based on failure to verify respective telemetry data signatures provided for the selected telemetry data sets.

In Example 30, the subject matter of any one or more of Examples 27-29 optionally include wherein the multi-chiplet telemetry monitoring unit synchronizes time across the multiple chiplets.

In Example 31, the subject matter of any one or more of Examples 27-30 optionally include wherein the multi-chiplet telemetry monitoring unit receives telemetry data events from the one or more hardware resources of the multiple chiplets.

In Example 32, the subject matter of any one or more of Examples 19-31 optionally include wherein the one or more hardware resources comprise a plurality of compute tiles, and wherein each compute tile comprises at least one processor core and at least one cache associated with the at least one processor core.

In Example 33, the subject matter of any one or more of Examples 19-32 optionally include wherein the one or more hardware resources and the telemetry monitoring circuitry are implemented in a processing chiplet, and wherein the processing chiplet is configured to connect to at least one other chiplet via an interconnect.

In Example 34, the subject matter of Example 33 optionally includes wherein the telemetry data is received via the interconnect using a data communication protocol, wherein the data communication protocol operates in accordance with a Universal Chiplet Interconnect Express (UCIe) standard.

Example 35 is at least one machine-readable medium (e.g., non-transitory machine-readable medium) comprising instructions stored thereon, which when executed by telemetry monitoring circuitry, causes the telemetry monitoring circuitry to: obtain telemetry data from a compute platform, the telemetry data produced from compute operations performed in one or more hardware resources of the compute platform; generate a signature of the telemetry data, based on a hash of the telemetry data; and communicate certified telemetry data to an external entity, the certified telemetry data including the telemetry data and the signature of the telemetry data.

In Example 36, the subject matter of Example 35 optionally includes the instructions further to cause the telemetry monitoring circuitry to: generate the hash of the telemetry data.

In Example 37, the subject matter of any one or more of Examples 35-36 optionally include the instructions further to cause the telemetry monitoring circuitry to: generate the signature based on a timestamp associated with the telemetry data.

In Example 38, the subject matter of Example 37 optionally includes the instructions further to cause the telemetry monitoring circuitry to: perform time synchronization among a plurality of hardware resources of the compute platform to synchronize the timestamp, prior to generating the signature.

In Example 39, the subject matter of any one or more of Examples 35-38 optionally include wherein the telemetry monitoring circuitry is configured to generate the signature based on a credential stored in the telemetry monitoring circuitry by a trusted party (e.g., manufacturer) associated with the telemetry monitoring circuitry.

In Example 40, the subject matter of any one or more of Examples 35-39 optionally include wherein the telemetry monitoring circuitry includes a temporary telemetry unit configured to securely buffer the telemetry data prior to generating the signature.

In Example 41, the subject matter of any one or more of Examples 35-40 optionally include wherein the telemetry monitoring circuitry is configured as a monitoring unit inside a chiplet, and wherein the chiplet includes the monitoring unit and the one or more hardware resources.

In Example 42, the subject matter of Example 41 optionally includes wherein the monitoring unit includes at least one interface to receive telemetry data events from the hardware resources within the chiplet.

In Example 43, the subject matter of any one or more of Examples 35-42 optionally include wherein the telemetry monitoring circuitry is configured as a multi-chiplet telemetry monitoring unit in a first chiplet to aggregate and certify telemetry data from the one or more hardware resources located among multiple chiplets, and wherein the instructions further to cause the telemetry monitoring circuitry to: validate telemetry data sets received from the multiple chiplets, based on success to verify respective telemetry data signatures provided for the telemetry data sets; aggregate the validated telemetry data sets; and generate an aggregated telemetry data signature based on at least one hash produced from the aggregated telemetry data sets.

In Example 44, the subject matter of Example 43 optionally includes wherein the multi-chiplet telemetry monitoring unit validates the respective telemetry data signatures based on a mapping between the multiple chiplets and certificate information corresponding to the multiple chiplets, wherein the mapping is provided in a mapping table that tracks chiplet information, certificate owner information, and certificate data, for a respective chiplet of the multiple chiplets.

In Example 45, the subject matter of any one or more of Examples 43-44 optionally include the instructions further to cause the telemetry monitoring circuitry to: reject selected telemetry data sets received from one or more of the multiple chiplets, based on failure to verify respective telemetry data signatures provided for the selected telemetry data sets.

In Example 46, the subject matter of any one or more of Examples 43-45 optionally include wherein the multi-chiplet telemetry monitoring unit synchronizes time across the multiple chiplets.

In Example 47, the subject matter of any one or more of Examples 43-46 optionally include wherein the multi-chiplet telemetry monitoring unit receives telemetry data events from the one or more hardware resources of the multiple chiplets.

In Example 48, the subject matter of any one or more of Examples 35-47 optionally include wherein the one or more hardware resources comprise a plurality of compute tiles, and wherein each compute tile comprises at least one processor core and at least one cache associated with the at least one processor core.

In Example 49, the subject matter of any one or more of Examples 35-48 optionally include wherein the one or more hardware resources and the telemetry monitoring circuitry are implemented in a processing chiplet, and wherein the processing chiplet is configured to connect to at least one other chiplet via an interconnect.

In Example 50, the subject matter of Example 49 optionally includes wherein the telemetry data is received via the interconnect using a data communication protocol, wherein the data communication protocol operates in accordance with a Universal Chiplet Interconnect Express (UCIe) standard.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

What is claimed is:

1. Processing circuitry, comprising:
compute circuitry, the compute circuitry including hardware resources to perform compute operations in a platform; and
telemetry monitoring circuitry to:
obtain telemetry data from the hardware resources, the telemetry data produced from the compute operations performed in the platform;
generate a signature of the telemetry data, based on a hash of the telemetry data; and
communicate certified telemetry data from the processing circuitry to an external entity, the certified telemetry data including the telemetry data and the signature of the telemetry data;
wherein at least one of the telemetry monitoring circuitry and the compute circuitry are implemented in at least one chiplet.

2. The processing circuitry of claim 1, wherein the telemetry monitoring circuitry generates the hash of the telemetry data.

3. The processing circuitry of claim 1, wherein the telemetry monitoring circuitry generates the signature based on a timestamp associated with the telemetry data.

4. The processing circuitry of claim 3, wherein the telemetry monitoring circuitry performs time synchronization among a plurality of hardware resources of the processing circuitry to synchronize the timestamp, prior to generation of the signature.

5. The processing circuitry of claim 1, wherein the telemetry monitoring circuitry generates the signature based on a credential stored in the telemetry monitoring circuitry by a trusted party associated with the telemetry monitoring circuitry.

6. The processing circuitry of claim 1, wherein the telemetry monitoring circuitry includes a temporary telemetry buffer that securely stores the telemetry data prior to generating the signature.

7. The processing circuitry of claim 1, wherein the telemetry monitoring circuitry is included as monitoring circuitry inside a chiplet that includes the hardware resources.

8. The processing circuitry of claim 7, wherein the monitoring circuitry includes at least one interface to receive telemetry data from the hardware resources within the chiplet.

9. The processing circuitry of claim 1, wherein the telemetry monitoring circuitry is multi-chiplet telemetry monitoring circuitry in a first chiplet to aggregate and certify telemetry data from the hardware resources of multiple chiplets, and wherein the multi-chiplet telemetry monitoring circuitry is to:
validate telemetry data sets from the multiple chiplets, based on success to verify respective telemetry data signatures provided for the telemetry data sets;
aggregate the validated telemetry data sets; and
generate an aggregated telemetry data signature based on at least one hash produced from the aggregated telemetry data sets.

10. The processing circuitry of claim 9, wherein the multi-chiplet telemetry monitoring circuitry validates the respective telemetry data signatures based on a mapping between the multiple chiplets and certificate information corresponding to the multiple chiplets, wherein the mapping is provided in a table that tracks chiplet information, certificate owner information, and certificate data, for a respective chiplet of the multiple chiplets.

11. The processing circuitry of claim 9, wherein the multi-chiplet telemetry monitoring circuitry rejects selected telemetry data sets from one or more of the multiple chiplets, based on failure to verify respective telemetry data signatures provided for the selected telemetry data sets.

12. The processing circuitry of claim 9, wherein the multi-chiplet telemetry monitoring circuitry includes timestamp coordination logic circuitry that synchronizes time across the multiple chiplets.

13. The processing circuitry of claim 9, wherein the multi-chiplet telemetry monitoring circuitry includes at least one interface to receive telemetry data events from the hardware resources of the multiple chiplets.

14. The processing circuitry of claim 1, wherein the hardware resources comprise a plurality of compute tiles, and wherein each of the compute tiles comprises at least one processor core and at least one cache associated with the at least one processor core.

15. The processing circuitry of claim 1, wherein the compute circuitry and the telemetry monitoring circuitry are implemented in a processing chiplet, and wherein the processing chiplet communicates with at least one other chiplet via an interconnect, wherein the telemetry data is received via the interconnect using a data communication protocol, and wherein the data communication protocol operates in accordance with a Universal Chiplet Interconnect Express (UCIe) standard.

16. At least one non-transitory machine-readable medium comprising instructions stored thereon, which when executed by telemetry monitoring circuitry, causes the telemetry monitoring circuitry to:
obtain telemetry data from a compute platform, the telemetry data produced from compute operations performed in hardware resources of the compute platform;
generate a signature of the telemetry data, based on a hash of the telemetry data; and
communicate certified telemetry data to an external entity, the certified telemetry data including the telemetry data and the signature of the telemetry data;
wherein at least one of the telemetry monitoring circuitry and the hardware resources are implemented in at least one chiplet.

17. The at least one non-transitory machine-readable medium of claim 16, the instructions further to cause the telemetry monitoring circuitry to:
generate the hash of the telemetry data;
generate the signature based on a timestamp associated with the telemetry data; and
perform time synchronization among a plurality of hardware resources of the compute platform to synchronize the timestamp, prior to generating the signature.

18. The at least one non-transitory machine-readable medium of claim 16, wherein the telemetry monitoring circuitry includes a temporary telemetry buffer that securely stores the telemetry data prior to generating the signature.

19. The at least one non-transitory machine-readable medium of claim 17, wherein the telemetry monitoring circuitry is included as monitoring circuitry inside a chiplet that includes the hardware resources, and wherein the monitoring circuitry includes at least one interface to receive telemetry data from the hardware resources within the chiplet.

20. The at least one non-transitory machine-readable medium of claim 16, wherein the telemetry monitoring circuitry is configured as a multi-chiplet telemetry monitoring circuitry in a first chiplet to aggregate and certify telemetry data from the hardware resources located among multiple chiplets, and wherein the instructions further to cause the telemetry monitoring circuitry to:
validate telemetry data sets from the multiple chiplets, based on success to verify respective telemetry data signatures provided for the telemetry data sets;
aggregate the validated telemetry data sets; and
generate an aggregated telemetry data signature based on at least one hash produced from the aggregated telemetry data sets.

21. The at least one non-transitory machine-readable medium of claim 20, wherein the multi-chiplet telemetry monitoring circuitry validates the respective telemetry data signatures based on a mapping between the multiple chiplets and certificate information corresponding to the multiple chiplets, wherein the mapping is provided in a table that tracks chiplet information, certificate owner information, and certificate data, for a respective chiplet of the multiple chiplets.

22. The at least one non-transitory machine-readable medium of claim 20, the instructions further to cause the telemetry monitoring circuitry to:
reject selected telemetry data sets from one or more of the multiple chiplets, based on failure to verify respective telemetry data signatures provided for the selected telemetry data sets.
